(19) United States
(12) Patent Application Publication
(10) Pub. No.: US 2008/0161108 A1
(43) Pub. Date: Jul. 3, 2008

(54) Wagering Game Machine Digital Audio Amplifier

(75) Inventors: John M. Dahl, Plymouth, MN (US); Timothy C. Loose, Chicago, IL (US)

Correspondence Address: SCHWEGMAN, LUNDBERG & WOESSNER/WMS GAMING, P.O. BOX 2938, MINNEAPOLIS, MN, 55402, US

(73) Assignee: WMS GAMING INC., Chicago, IL (US)

(21) Appl. No.: 11/569,022

(22) PCT Filed: May 12, 2005
(86) PCT No.: PCT/US05/16607

§ 371 Date: Sep. 10, 2007

Related U.S. Application Data
(60) Provisional application No. 60/570,706, filed on May 13, 2004.

(51) Int. Cl. A63F 13/00; G06F 17/00; A63F 9/24

(52) U.S. Cl. 463/35; 381/120

(57) ABSTRACT

A computerized wagering game system has a gaming module comprising a processor and gaming code which is operable when executed on the processor to conduct a wagering game on which monetary value can be wagered, and an audio module comprising a digital audio amplifier, the audio module operable to receive digital audio signals and to amplify them to produce an amplified digital audio signal. In some embodiments, the digital amplifier produces a pulse width modulated amplified digital audio signal, which is in further embodiments also pulse frequency modulated.

### RELATED APPLICATION(S)

This application claims priority to U.S. Application No. 60/570,706 filed on May 13, 2004 which is incorporated herein by reference.

### FIELD OF THE INVENTION

The invention relates generally to wagering gaming systems, and more specifically to digital audio amplifiers in computerized wagering game systems.

### BACKGROUND OF THE INVENTION

A wide variety of gaming devices are now available to gamers and to casino operators in computerized form, from slot machines to games that are traditionally played live such as poker and blackjack. These computerized games provide many benefits to the game owner and to the gambler, including greater reliability than can be achieved with a mechanical game or human dealer, more variety, sound, and animation in presentation of a game, and a lower overall cost of production and management.

Computerized video game systems must be designed with many of the same concerns as their mechanical and table game ancestors—they must be fair, they must provide sufficient feedback to the gamer to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Many computer elements have been employed in gaming systems, from computerized animation to playing prerecorded sounds through a gaming system's speakers. These are carefully designed, along with the general theme and other elements of a gaming system, to attract the attention of gamers and to provide a memorable gaming experience. These sounds are loaded within the computerized gaming machine and played through speakers to supplement the wagering game experience, much as is done with personal computer games and television-based video games.

In traditional systems, a digital audio signal generated within the wagering game system is converted to an analog audio signal by a digital to analog converter, and is amplified by an analog audio amplifier before being sent to one or more speakers. The analog audio amplifier produces not only an amplified analog audio signal, but also typically produces a great deal of heat. Efficiency of such analog amplifiers is typically well under 50 percent, meaning that for every watt of power delivered to a speaker, more than one watt of power is dissipated as heat.

Because use of such analog audio amplifiers requires careful management of heat within the wagering game and because increased power efficiency is a desirable goal, it is desired to have a wagering game audio system employing an audio amplification system that addresses these problems.

### SUMMARY OF THE INVENTION

The present invention provides in one embodiment a computerized wagering game system having a gaming module comprising a processor and gaming code which is operable when executed on the processor to conduct a wagering game on which monetary value can be wagered. The wagering game system further comprises an audio module comprising a digital audio amplifier, the audio module operable to receive digital audio signals and to amplify them to produce an amplified digital audio signal. In some embodiments, the digital amplifier produces a pulse width modulated amplified digital audio signal, which is in further embodiments also pulse frequency modulated.

### BRIEF DESCRIPTION OF THE FIGURES

FIG. 1 shows a computerized reel slot gaming system having a an audio module including a digital amplifier, consistent with an embodiment of the present invention.

FIG. 2 is a block diagram of one embodiment of the prior art.

FIG. 3 is a block diagram of a wagering game audio module featuring digital amplifiers, consistent with an embodiment of the present invention.

FIG. 4A shows a pulse width modulated digital audio signal, as is produced in an example embodiment of the present invention.

FIG. 4B shows an analog audio signal corresponding to the pulse width modulated digital audio signal of FIG. 4A.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in one embodiment a computerized wagering game system having a gaming module comprising a processor and gaming code which is operable when executed on the processor to conduct a wagering game on which monetary value can be wagered, and an audio module including digital amplification. Various embodiments of the invention will incorporate different digital amplification technologies, such as are operable to output pulse width modulated amplified signals, or signals that are further pulse frequency modulated.

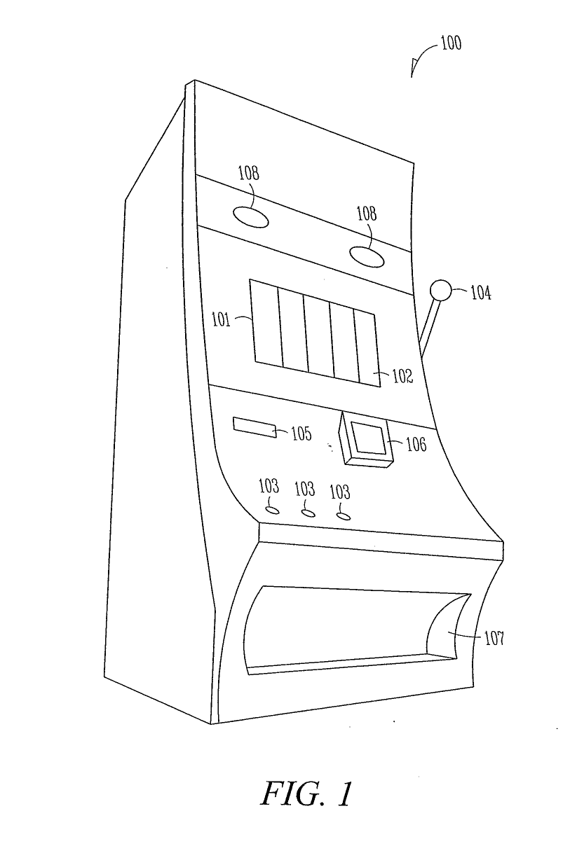

FIG. 1 illustrates a computerized wagering game machine, as may be used in an embodiment of the present invention. The computerized gaming system shown generally at 100 is a video gaming system, which displays information for at least one wagering game upon which monetary value can be wagered on video display 101. Alternate embodiments of the invention will have other game indicators, such as mechanical reels instead of the video graphics reels 102. The game of chance is played and controlled with various buttons 103, and in some embodiments also with a pull arm 104 to initiate reel spin. Value is wagered on the games, such as with tokens, coins, bills, or cards that hold value. The wagered value is conveyed to the machine through a changer 105 or a card reader 106, and winnings are returned via the returned value card or through the coin tray 107. The audio module generates or receives digital audio signals to be played, and provides an amplified digital signal to the speakers 108.

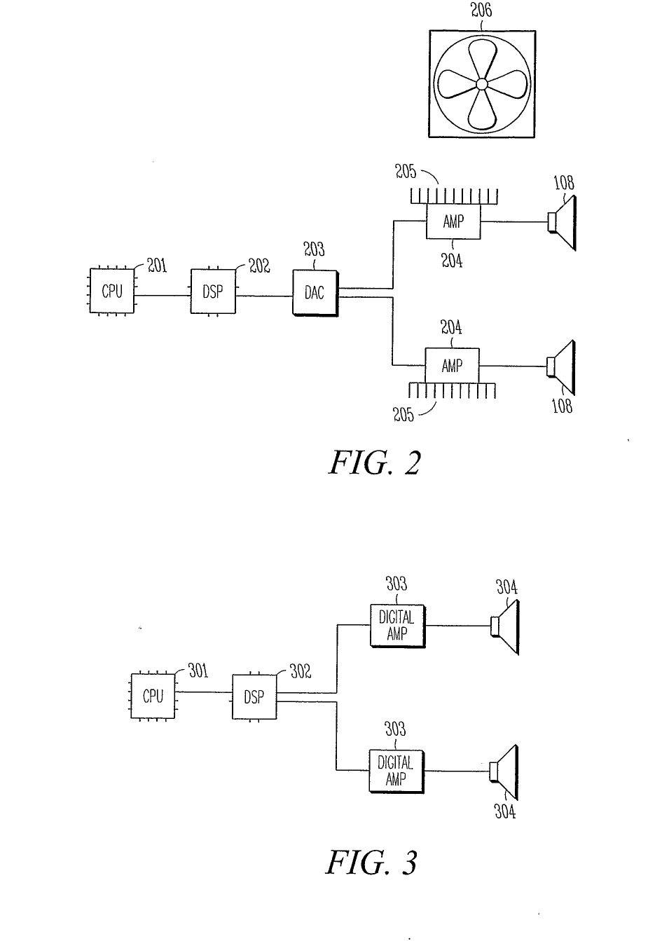

FIG. 2 illustrates an audio module as may be found in a typical prior art wagering game machine. A central processing unit 201 executing software sends an audio signal or instructions to play audio to an audio digital signal processor (DSP) 202. The audio DSP generates and outputs a digital audio signal to a digital-to-analog converter (DAC) 203, which converts the digital audio signal to an analog audio signal. From there, the analog audio signal is amplified via analog audio amplifiers 204 before being sent to speakers 108. The analog audio amplifier in some embodiments comprises both a buffer amplifier stage coupled to the DAC output, and a power amplifier stage coupling the buffer amplifier stage to the speakers. Additionally, filtering of the analog signal often takes place within the amplifier, such as within the buffer stage to limit its output to audio frequencies, and within or after the power amplifier stage to limit the frequencies provided to each speaker 108 to those appropriate for each individual speaker.

Because efficiencies of analog amplifiers are typically well under 50%, the amplifiers 204 will typically radiate as much or more energy in heat than they will provide to the speakers 108. This requires heat sinks 205 to help dissipate the heat, and in some further embodiments requires additional measures such as fan 206 to draw air across the heat sinks, making the heat sink cooling of the analog amplifiers more efficient.

The present invention as shown in the example embodiment of FIG. 3 employs a digital audio amplifier, which in some embodiments provides a benefit of greater efficiency and significantly lower heat production. Central processing unit 301 again executes software and sends an encoded digital audio signal or instructions to play audio to audio digital signal processor (DSP) 302. The audio DSP generates the digital audio signal and provides it as an output, but it is routed to digital amplifiers 303 rather than to digital to analog converter 203 as was employed in the prior art example of FIG. 2. The digital audio signal sent to the digital amplifiers is in some embodiments encoded as a pulse code modulated signal, which digitally expresses the amplitude of an audio signal at regular intervals, such that the amplitude expressions are known as a sample and the interval between samples is known as the sampling rate. The digital audio signal is received in the digital amplifier, is amplified, and provided as an amplified digital signal to the speakers 304.

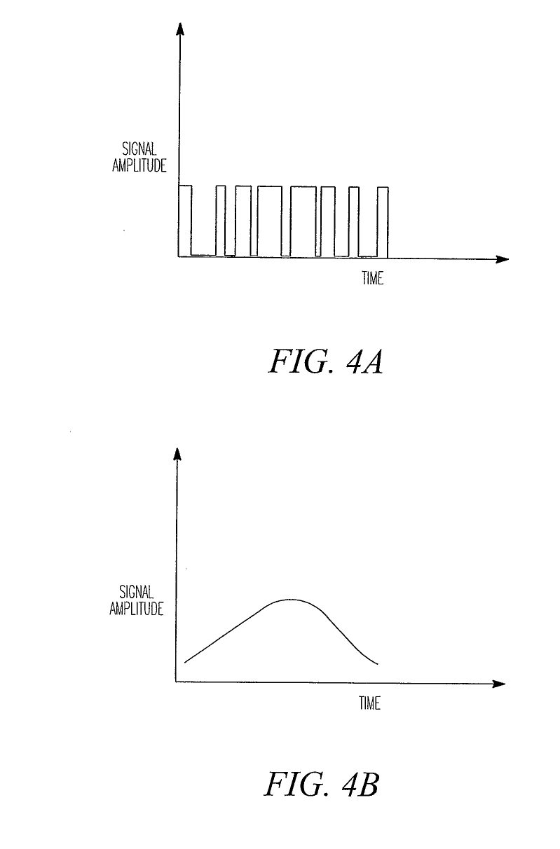

The digital amplifier 303 in one embodiment of the invention receives a digital signal such as a pulse code modulated signal, and generates a pulse width modulated signal output. A pulse width modulated signal differs from a pulse code modulated signal in that the width of the digital pulses produced are used to encode the output level. FIG. 4A represents a pulse width modulated encoding of the analog signal of FIG. 4B. Pulses occur at regular intervals in the pulse width modulated signal of 4A, and the duration of each pulse is dependent on the amplitude of the corresponding encoded analog signal. Where the pulses remain at a high level for a greater duration in 4A, the analog signal is at a relatively high amplitude in the analog signal of 4B.

Such coding is employed in digital amplification in some embodiments of the invention, and will typically follow certain parameters. For example, the pulse rate of the pulse train of a pulse width modulated signal such as that of FIG. 4A will typically occur at a rate significantly faster than the frequency of the highest frequency audio signal that will be represented. This ensures greater resolution and fidelity in the encoded signal, and improves the quality of the audio produced through the speakers. Typical pulse rates are from the low hundreds of kiloHertz to the high hundreds of kiloHertz. Still further embodiments of the invention will not use regularly timed pulses to produce the amplified digital output signal, but will modify the interval between pulses depending on the frequency content of the digital signal being amplified. This modification of the pulse frequency is called pulse frequency modulation, and can be employed either alone with fixed width pulses, or in combination with pulse width modulation.

The digital signal output from the digital amplifier 303 is typically filtered using ana analog filter, such as a simple network having capacitors or inductors, to pass low frequencies. Such a filter allows smooth, low frequency signals within the audio band such as that of FIG. 4B to pass, while filtering out the higher frequency content of the pulses as are shown in FIG. 4A. In some further embodiments, filters are further employed, either between the digital amplifiers and the speakers, or before or within the digital amplifiers, to limit the frequencies sent to a particular speaker to only those frequencies a particular speaker is designed to produce. For example, higher audio frequencies are routed to a tweeter and lower audio frequencies are routed to a midbass speaker driver in some embodiments of the invention via such a filter, also known as a crossover filter. Each speaker may or may not have its own digital amplifier, depending on where in the audio module the crossover filter is placed.

Many examples of digital amplifiers are already commercially produced and available on the market, including technologies such as Equibit, from Texas Instruments™, and Tripath™. The Equibit digital amplifier converts pulse code modulated signals to pulse width modulated amplified signals, while the Tripath amplifier is described by its producers as a digital-analog hybrid or a combinant digital amplifier. Such an amplifier comprises a digital amplifier component, and is within the scope of the present invention. Other examples include Analog Devices' AD1991, and other such digital amplifiers, many of which boast efficiencies of 80-90% or more. Many digital audio amplifiers do not appear to be amplifiers in a traditional sense, but are capable of receiving a low-power digital audio signal and producing through digital circuitry a high power digital audio signal. Such high-output capable digital modulation circuits are commonly included in the realm of digital amplifiers in the art, and for purposes of the present invention.

The example embodiments of the present invention illustrated here have shown how an audio module in a wagering game machine may employ digital amplification to improve efficiency, reduce heat production, and eliminate various components needed in traditional analog systems needed to control and dissipate heat. Various examples of digital amplifier technologies were presented, along with discussion of various other components such as filters that will be employed in different embodiments of the invention. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A computerized wagering game system, comprising:
a gaming module comprising a processor and gaming code which is operable when executed on the processor to conduct a wagering game on which monetary value can be wagered, and
an audio module comprising a digital audio amplifier, the audio module operable to receive digital audio signals and to amplify them to produce an amplified digital audio signal.

2. The computerized wagering game system of claim 1, wherein the digital audio amplifier is operable to output a digital output signal.

3. The computerized wagering game system of claim 1, wherein the digital audio amplifier is operable to output a pulse width modulated digital audio signal.

4. The computerized wagering game system of claim 1, wherein the digital audio amplifier is operable to output a pulse frequency modulated digital audio signal.

5. The computerized wagering game system of claim 1, wherein the audio module further comprises at least one transistor coupled to amplify a digital audio signal.

6. The computerized wagering game system of claim 1, wherein the audio module further comprises at least one digital filter operable to reduce the audio content of the signal at certain frequencies from a received digital signal.

7. The computerized wagering game system of claim 1, wherein the audio module further comprises an analog lowpass filter coupled between an output of the digital audio amplifier and a speaker.

8. A method of operating a computerized wagering game machine, comprising:
producing a digital audio signal; and
amplifying the digital audio signal in a digital audio amplifier in an audio module,
wherein the computerized wagering game machine further comprises a processor and gaming code which is operable when executed on the processor to conduct a wagering game on which monetary value can be wagered

9. The method of claim 8, wherein the digital audio amplifier is operable to output a digital output signal.

10. The method of claim 8, wherein the digital audio amplifier is operable to output a pulse width modulated digital audio signal.

11. The method of claim 8, wherein the digital audio amplifier is operable to output a pulse frequency modulated digital audio signal.

12. The method of claim 8, wherein the audio module further comprises at least one transistor coupled to amplify a digital audio signal.

13. The method of claim 8, further comprising filtering the digital audio signal in a digital filter to reduce the audio content of the signal at certain frequencies.

14. The method of claim 8, further comprising filtering the amplified digital audio signal with an analog lowpass filter coupled between an output of the digital audio amplifier and a speaker.

15. A computerized wagering game system, comprising:
a gaming module comprising a processor and gaming code which is operable when executed on the processor to conduct a wagering game on which monetary value can be wagered;
a digital audio amplifier, the audio module operable to receive a pulse code modulated digital audio signal, to convert the received pulse code modulated digital audio signal to a pulse width modulated digital audio signal, and to output an amplified pulse width modulated digital signal; and
at least one speaker coupled to receive the amplified pulse width modulated digital signal.

16. The computerized wagering game system of claim 15, wherein the digital audio amplifier is further operable to pulse frequency modulate the received digital audio signal.

17. The computerized wagering game system of claim 15, further comprising an analog lowpass filter coupled between the digital audio amplifier and the at least one speaker.

18. The computerized wagering game system of claim 15, further comprising at least one digital filter coupled to process the pulse code modulated digital audio signal to reduce the audio content of the signal at certain frequencies.

19. A method of operating a computerized wagering game system, comprising:
receiving a pulse code modulated digital audio signal;
converting the received pulse code modulated digital audio signal to a pulse width modulated digital audio signal;
outputting an amplified pulse width modulated digital audio signal; and
receiving in a speaker the amplified pulse width modulated digital audio signal;
wherein the computerized wagering game machine further comprises a gaming module comprising a processor and gaming code which is operable when executed on the processor to conduct a wagering game on which monetary value can be wagered.

20. The method of claim 19, further comprising pulse frequency modulating the received digital audio signal.

21. The method of claim 19, further comprising filtering the amplified pulse width modulated digital audio output signal with an analog lowpass filter coupled between the digital audio amplifier and the speaker.

22. The method of claim 19, further comprising filtering the pulse code modulated digital audio signal to reduce the audio content of the signal at certain frequencies.
